(19) United States
(12) Patent Application Publication
(10) Pub. No.: US 2017/0002669 A1
(43) Pub. Date: Jan. 5, 2017

(54) MECHANICAL FASTENING SYSTEM FOR ROTATING OR STATIONARY COMPONENTS

(71) Applicant: General Electric Technology GmbH, Baden (CH)

(72) Inventors: Jaroslaw Leszek SZWEDOWICZ, Bad Zurzach (CH); Andreas BAUER, Baden (CH); Jonas BOETTCHER, Hannover (DE); Marcus NEUBAUER, Hannover (DE)

(73) Assignee: General Electric Technology GmbH, Baden (CH)

(21) Appl. No.: 15/113,062

(22) PCT Filed: Nov. 3, 2014
(86) PCT No.: PCT/EP2014/073554

§ 371 Date: Jul. 21, 2016

(30) Foreign Application Priority Data
Jan. 21, 2014 (EP) 14152020.5

(51) Int. Cl. F01D 5/30; F01D 25/24; F01D 9/04

(52) U.S. Cl. CPC F01D 5/3038; F01D 9/042; F01D 25/246; F05D 2220/32; F05D 2260/30; F05D 2300/505; F05D 2300/501; F05D 2300/171; F05D 2300/603

(57) ABSTRACT

A mechanical fastening system for rotating or stationary components such as turbine or compressor blades on a rotor or a shaft or a casing, respectively, is disclosed. The system includes a circumferential mounting groove adapted for receiving root sections of the rotating or stationary components as well as intermediate fastening components for fixation of the components in equidistance positions. The intermediate fastening components comprise at least an upper platform and at least a side plate having a groove for mounting on said rotor. The intermediate fastening components are made of a plurality of distinct parts of different materials from which at least one clamping part is made of or comprises a shape memory alloy or similar material having a pseudo-elasticity behavior.

### BACKGROUND OF INVENTION

Embodiments of the present invention relate to a mechanical fastening system for rotating or stationary components, such as turbine blades/vanes or compressor blades/vanes on a rotor or a shaft respectively vane carrier of a casing.

The blades and vanes in gas turbines or compressors with several stages are mounted on the rotor respectively vane carrier by means of a circumferential mounting groove, into which the single blades are respectively inserted and fixed by means of so-called intermediate fastening components. Such a mechanical fastening system has the purpose that the respective turbine blades are fixedly installed at their pre-described installation position and may in case of damages be replaced by new blades. Furthermore, such a fastening system for turbine or compressor blades and vanes is required to be adapted to the respective operation conditions, such as the high temperatures and loadings during the operation of a gas turbine or the like.

It is necessary that such fastening systems for blades or vanes of the turbine or the compressor do not only have the predetermined small tolerances with respect to other components, but are also adapted to damp possible vibrations, which may result in damages to the blades or vanes and turbine and compressor components.

Besides the required resistance against stresses during the operation, which act on the blades and the blade fastening system, the fastening system for such rotating components has also to be adapted in order to assure a secure blade fixation in the most stable and robust manner. In the construction of gas turbines, for example, such fastening systems for the blades are therefore a critical issue and require very small tolerances and a reliable clamping effect such that the long-term operation of the gas turbine is guaranteed. In case of damages to some of the blades or replacement requirements, the fastening system should also be adapted for a fast and easy disassembly.

A conventional mechanical fastening system for rotating components such as gas turbine blades includes on the side of the rotor a circumferential mounting groove with a shape adapted for receiving the so-called root sections of the blades as well as intermediate fastening components, which have the corresponding cross-section form of the mounting groove. Such a known mechanical fastening system for turbine blades is, for example, shown in FIG. 1 and FIG. 2 of the attached drawings.

In case of this conventional fastening system 10, the blades 1 are provided with root sections 2 having a specific cross-section adapted for an insertion into a circumferential mounting groove (not shown) on the rotor, in particular in several respective stages of the compressor or turbine. The solid intermediate fastening components 3 have for example a cross-section with several lateral grooves 4 (cf. cross-section A-A of FIG. 2) for the fastening in a circumferential mounting groove of a rotor or shaft (not shown). These intermediate fastening components are usually made of a metal material or alloy in a solid form and have therefore to be manufactured within very small tolerances in order to meet the described design requirements. In addition to these intermediate fastening components 3, which have the purpose of clamping the respective blades 1, so-called T-root spacers are used for the exact positioning of the blades 1 within the gas turbine or compressor. These conventional fastening systems with solid intermediate fastening components for the purpose of a fixation and clamping of the blades require therefore very small tolerances in view of the shape and form of the components. Furthermore, the assembly and disassembly of such a fastening system is rather complicated.

For example, special tooling is required for the mounting and a later disassembly of such a fastening system. Frequently, also the disassembly of such a fastening system is not easy to achieve due to different wear driving by stochastic vibrations of the engine during operation. After a certain time of operation, the intermediate fastening components firmly clamp the blades and additional spacer elements within the circumferential groove of the rotor such that a removal of the fastening system is only possible by using additional specific tooling.

A further disadvantage of such known fastening systems for rotating or stationary components with solid intermediate fastening components or clamping components is that they are not well adapted in view of a damping of vibrations and resonances during the operation of such engines. Furthermore, these known mechanical fastening systems are rather heavy in terms of weight, because the materials, such as metal alloys, used for the manufacturing of the components have to be adapted to the above-described operational conditions with high temperatures and increased loads.

### BRIEF DESCRIPTION

In view of these disadvantages, it is an object of the present invention to provide an improved mechanical fastening system for rotating or stationary components for use in temperature- and stress-critical engines, which provides a reliable high clamping force and enables at the same time an easy mounting and disassembly of the fastening system. Furthermore, the fastening system according to embodiments of the invention may be optimized in view of a damping of operational vibrations or the like.

This problem is solved by means of a mechanical fastening system according to embodiments of the invention.

The mechanical fastening system for rotating or stationary components such as turbine or compressor blades on a rotor or a shaft or vanes on a vane carrier in a casing according to an embodiment of the present invention includes a circumferential mounting groove adapted for receiving root sections of the blades or vanes as well as intermediate fastening components for a fixation of the blades or vanes in predefined equidistance positions on the circumference of the rotor resp. vane carrier. The intermediate fastening components include at least an upper platform and at least a base or side plate having a groove for a mounting on the rotor or on the casing. The fastening system according to an embodiment of the invention is characterized in that the intermediate fastening components are made of a plurality of distinct parts of different materials or material compositions, from which at least one clamping part is made of or includes a shape memory alloy or similar materials having a pseudo-elasticity behavior. Since the intermediate fastening components are made of a plurality of distinct parts of different materials, the parts can be adapted to the respective specific requirements in terms of resistance and rigidity, in particular in view of high temperatures and increased stresses. At least one of the plurality of distinct parts is a clamping part, which is made of or includes a shape memory alloy or a similar material, so that the clamping effect for retaining and fixing the fastening system is provided by this clamping part. The clamping part can be modified in its form for the purpose of a mounting and a disassembly of the fastening system as compared to the normal operational state of the clamping part, in which the clamping part has a shape and structure adapted for providing the required clamping effect. Due to this feature, according to an embodiment of the invention, it is possible to design the other parts of the intermediate fastening component with such dimensions that an easy mounting and disassembly are possible. The other parts may for example be realized in ordinary steel or composite materials, the shapes of which can be optimized topologically in terms of acting external thermal and mechanical stresses during an operation of the engine such as a gas turbine. By means of this, the fastening system is less sensitive with regard to mounting tolerances. Nevertheless, the fastening system provides a very exact assembly tolerance and precise positioning with a kind of self-fastening light-weight system.

The final operational shape and design of the intermediate fastening component is only given in case of the final operational condition. That means, the clamping effect of the fastening system is triggered by the operational conditions, such as the higher operation temperatures or the operation pressures on the fastening system, which can be determined on the basis of experiments or known ranges of temperatures of the operation of the engine. The shape memory alloy or similar material used for the clamping part of the intermediate fastening components is chosen such that at ambient temperature and without increased load the clamping effect is removed, whereas during an operation of the gas turbine or similar engine the required clamping effect is given. Hereby, a kind of hybrid mechanical fastening system is provided, which enables an easy disassembly in case of a replacement of damaged blades, for example. After a shutdown of the engine, which may be a compressor or a turbine or the like, the clamping part goes back to an initial predefined shape such that the fastening system and the related blades can be removed without necessarily using an additional tool.

In addition, the clamping parts made of a shape memory alloy provide an extraordinary material damping, which is higher than in the case of the material damping of prior art intermediate fastening components, which are made of one single material and are realized as a single-piece element. Due to this feature, the entire engine assembly is furthermore protected from high cyclic fatigue problems, which may for example be caused by a rubbing of rotating blades against the housing of a compressor or turbine, which might particularly occur during the start-ups and shutdowns of the engine. As a shape memory alloy or similar material having a pseudo-elasticity behavior for the clamping part of the intermediate fastening components, any material of this kind known to the person skilled in the art can be used. For example, metal alloys, such as NiTi, CuZnAl, CuAlNi or alloys on the basis of iron can be used, depending on the respective operation conditions, in particular the temperature ranges during an operation of the turbine or compressor. Such materials of shape memory alloys have the specific characteristic that an initial shape of the clamping part can be adjusted for the purpose of the mounting and disassembly of the fastening system, which is then modified during the operational conditions, which can for example be triggered by the higher temperatures or higher stresses during the operation of an engine. For example, the clamping part is made of such a shape memory alloy, which has a high ductility of the material in the non-operation state due to the detwinning of the martensite variants such that the clamping part and therefore the fastening system can easily be deformed using a simple tool or by hand. Contrary thereto, in the operational conditions, the material changes to an austenitic state, in which the final (increased) shape of the clamping part is given such that the clamping effect for the fastening and retaining of the rotating components is given. That means, the higher operational temperatures of the engine are used to install the austenite finish temperature of the material, which creates stresses such that the clamping of the entire system is guaranteed in the austenitic state of the material. The modification of the shape due to this pseudo-elasticity behavior of the clamping part may, according to an embodiment of the invention, be triggered by means of an operation temperature (increased temperature), an external mechanical loading acting on the fastening system, or the like.

Hereby, embodiments of the present invention provide an improved fastening system, which enables the easy mounting and disassembly of the components of the system. The fastening system, according to embodiments of the invention, can also be adapted in terms of weight, e.g. the different parts can be specifically adapted to the requirement of mechanical and thermal resistance considering the total weight of the fastening system. In total, a rather light-weight construction is provided, which can be mounted and disassembled with simple tools or even by hand. Finally, the fastening system according to embodiments of the invention, also provides particular advantageous damping properties due to the different materials and in particular the shape memory alloy used for the clamping part of the intermediate fastening components. Resonances occurring during an operation of the engine may be damped in a better manner, and therefore the damages caused by a high-cyclic fatigue in conventional engines of this kind can be reduced. Also the fastening system is optimized in view of the possibility of transport since the different separate parts of the fastening system may be stored and transported separately. The clamping part according to an embodiment of the invention related to the fastening system can completely be made of a so-called shape memory alloy, or may include parts, which are realized in such a shape memory alloy or similar materials.

According to an aspect of the invention, the clamping part of the fastening system made of a shape memory alloy or a similar material having a pseudo elasticity behavior is a clamping bolt. With such a clamping bolt used as a part of the plurality of distinct parts of the intermediate fastening component, a good fastening condition with rather simple components of the fastening system is realized. Furthermore, the assembly abilities are increased, since the other parts of the intermediate fastening components may be realized in less strict manufacturing tolerances. Nevertheless, the fastening system provides an exact positioning and fixation of the turbine blades or the like. A clamping bolt according to an embodiment of the invention can, in view of the respective design requirements, be adapted in its form and in the use of the shape memory alloys. For example, the clamping bolt may be a cylindrical bolt made of a shape memory alloy, which includes at least in part a shape memory alloy. Such a clamping bolt can for example be inserted into respective cavities or bores within the other parts of the intermediate fastening component such that during operational conditions, when the final shape of the clamping bolt is given, the required clamping effect is achieved.

According to a further aspect of the invention, the intermediate fastening components include a platform and a side plate, which are separate parts and which are mounted to one another by means of a groove/undercut combination. During the installation of the fastening systems, these different parts can simply be brought together within the circumferential mounting groove of a rotor. The clamping part can then be installed, and the fastening system is thereby completed for the first operation of the engine. Furthermore, a separate platform and side plate have the advantage that these parts can specifically be adapted in view of their operational requirements by using different materials or material alloys.

According to a further embodiment of the invention, the side plate or side plates of the intermediate fastening components include a cavity for receiving the clamping part made of a shape memory alloy. Thereby, the clamping part is securely held within the other parts of the intermediate fastening component. A clamping effect can be provided at specific predefined positions within the fastening system such that a secure fixation and retaining of the intermediate fastening components and thereby also the turbine or compressor blades is given. According to an embodiment of the invention, the cavities have a diameter, which is slightly larger than the diameter of the clamping part, which is inserted into these cavities. Thereby, the installation and the disassembly of the fastening system are made easier, because the clamping parts can easily be removed by hand after a shutdown of the engine at ambient temperature, for example.

According to a further embodiment of the invention, the fastening system includes two or more circumferential side plates. With two circumferential side plates, the clamping part made of a shape memory alloy can be inserted between these two side plates. When the operational condition is given such that the clamping part provides the clamping effect due to this shape memory alloy or similar materials, the two side plates provide an excellent clamping effect because the adjacent surfaces of the root of the turbine blades, for example, are uniformly clamped on an increased area or surface. Depending on the design requirements and the respective distribution of turbine blades, additional side plates can also be used in the fastening system.

According to a further embodiment of the invention, a spring element or a plurality of spring elements for fastening the intermediate fastening components are provided. With this feature, the preassembly of the fastening system is made easier: the spring elements provide already before a final operation condition is given a kind of holding effect of the respective components such that the final positioning of the blades is guaranteed. The spring elements can be provided by normal springs, such as helical springs, or by springs made of a shape memory alloy in addition to the clamping part. It is also possible to provide spring elements of a shape memory alloy or similar material as a clamping part as such or a combination of both.

According to a further embodiment of the invention, the side plate(s) of the intermediate fastening components includes a guide surface or guiding groove for receiving and guiding a clamp element. With such a guide surface or a guiding groove, the installation of the fastening system is made easier. The clamp element is directly moved to the final position between the different distinct parts of the intermediate fastening component. An operator does not have to search for the pre-described installation site of the clamp element when installing the turbine blades and the intermediate fastening components.

According to a further embodiment of the invention, a plurality of clamping parts made of a shape memory alloy or similar material is provided. By increasing the number of clamping parts, the total clamping effect can be increased. Also the distribution of the clamping effect on the contacting surfaces with regard to the adjacent root parts of the turbine blades is thereby improved.

According to a further embodiment of the invention, the at least one clamping part of the intermediate fastening components has an inner core made of ordinary steel or a composite material, on which core a helical spring is wound made of a shape memory alloy or a similar material showing a pseudo-elasticity behavior. Hereby, the clamping part is not completely made of a shape memory alloy or a similar material, but only a part of it is made of such a material. The clamping properties and the operational properties of the clamping part and the complete fastening system can thereby be adapted to respective specific requirements of a construction of an engine.

According to a further s embodiment of the invention, the type of shape memory alloy or similar material for the clamping part is specifically selected depending on the temperature range during the operation of a turbine or component or a respective installation location or stage of the turbine or compressor. Since in conventional gas turbines, for example, different stages of rows of turbine blades are given, in which different temperatures are present, the fastening system can be adapted to the respective temperature ranges or ranges of loads or stresses by means of this. Thereby, a uniform clamping effect of all clamping parts over the whole construction of the engine is achieved, which has the advantage that the damping of operational vibrations and the like is also uniform within the whole system. By means of this, possible damages due to vibrations or the like are considerably reduced.

### BRIEF DESCRIPTION OF THE DRAWINGS

In the following, embodiments of the present invention will be described in more detail on the basis of some examples of realization and with reference to the attached drawings, in which:

FIG. 1 is a schematic perspective drawing showing a mechanical fastening system of the prior art with solid intermediate fastening components;

FIG. 2 is a schematic side view of a prior art intermediate fastening component according to a prior art fastening system;

FIG. 3A is a side view of an intermediate fastening component for a fastening system according to an embodiment of the invention;

FIG. 3B, 3C are respective cross-sections B-B and C-C of the intermediate fastening component of FIG. 3A;

FIG. 4 is a side view of an upper platform of the intermediate fastening component according to an embodiment of the invention;

FIG. 5A is a side view of a side plate of an embodiment of the intermediate fastening component according to an embodiment of the invention;

FIG. 5B, 5C are cross-sections B-B and C-C of the side plate according to FIG. 5A;

FIG. 6B, 6C are respective side views of a clamping bolt of the intermediate fastening component according to an embodiment of the invention.

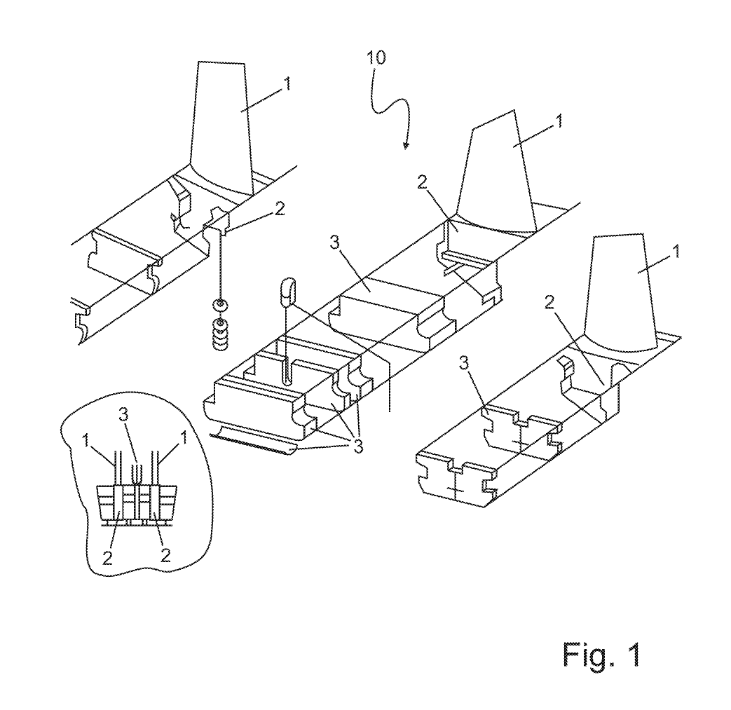

### DETAILED DESCRIPTION OF

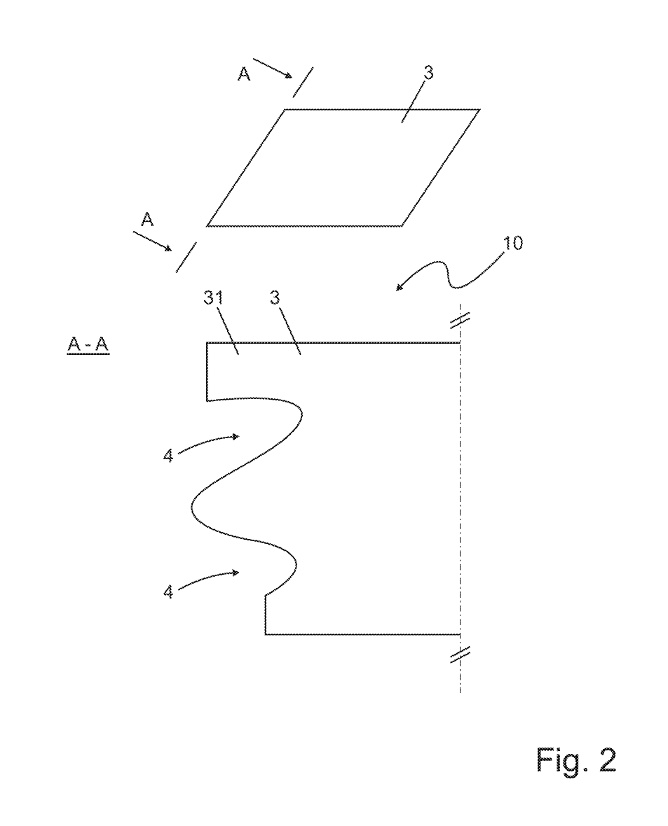

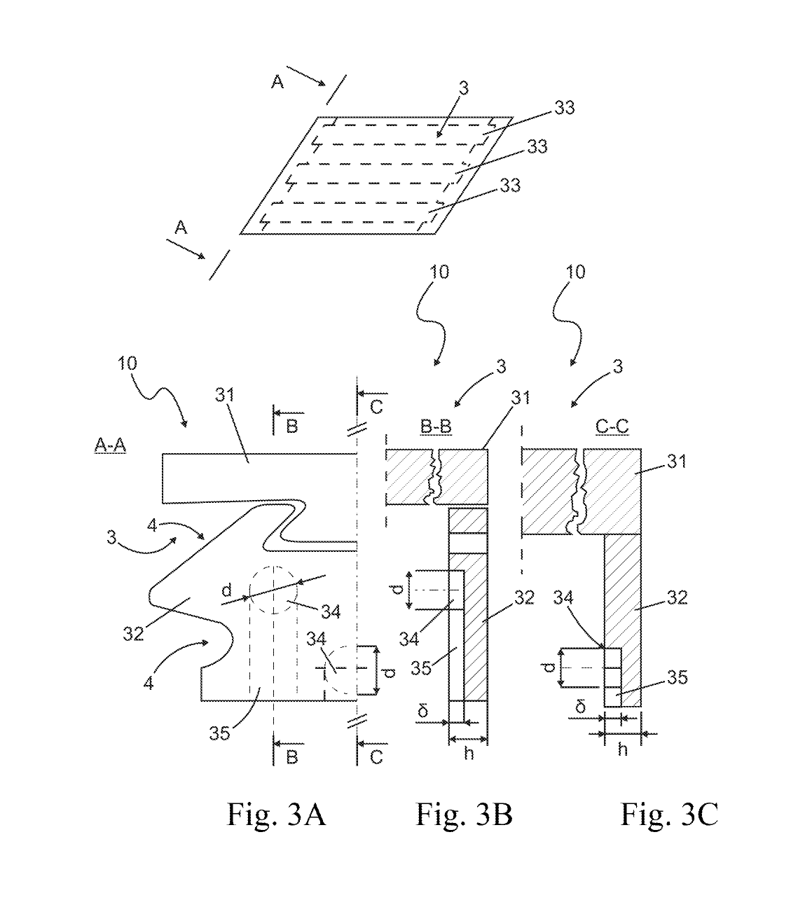

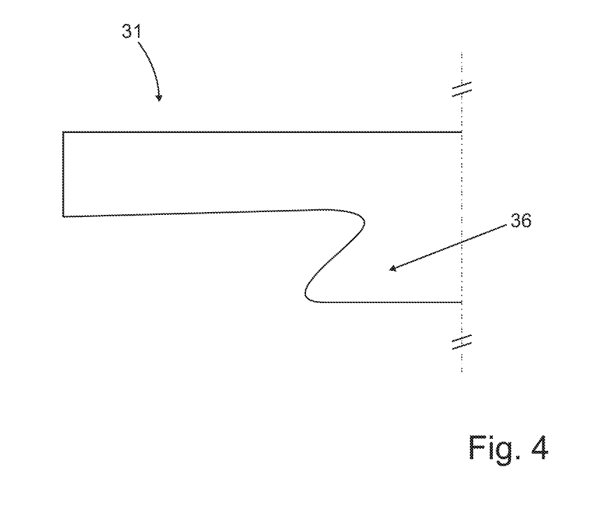

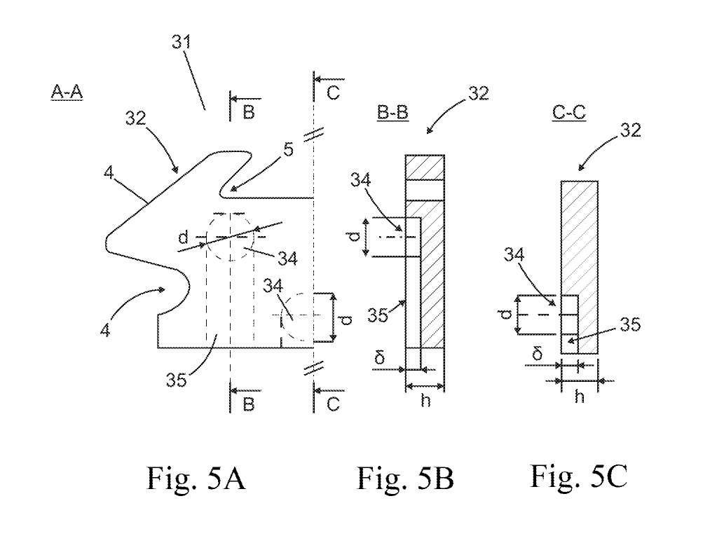

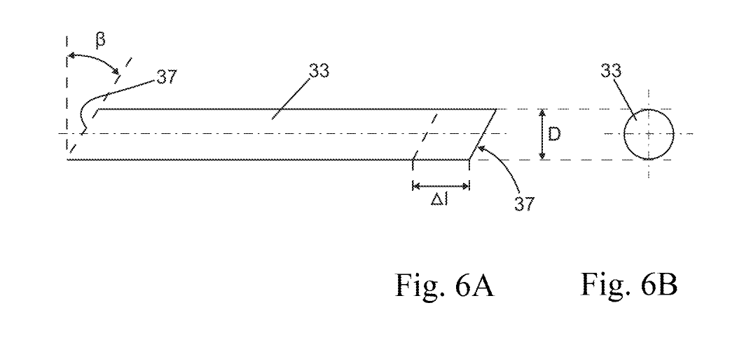

An embodiment of the mechanical fastening system 10 for rotating components such as turbine blades 1 is shown in the drawings of FIG. 3A to FIG. 6B. The fastening system 10 includes several intermediate fastening components 3 of a similar cross-section as compared to the cross-section of the prior art intermediate fastening component 3 shown in FIG. 2. Contrary to the prior art intermediate fastening component 3A, the intermediate fastening component 3 according to an embodiment of the present invention is composed of a plurality of distinct parts 31, 32, 33 shown in the schematic side view of FIG. 3A and shown in the detail views of FIG. 4 to FIG. 6C. According to an embodiment of the invention, a kind of hybrid fastening component 3 for the mechanical fastening system 10 of turbine blades 1 or compressor blades 1 is provided, which includes according to the embodiment shown in the drawings an upper platform 31, at least two side plates 32 and three clamping bolts 33 (cf. FIG. 3A and FIG. 6B). The upper platform 31 is of an essentially plate shape with a root 36 of such a form, which is adapted to be inserted into a fastening groove 5 of the respective circumferential side plates 32 (cf. FIG. 3A). The side plates 32 of the intermediate fastening component 3 according to this embodiment are shaped with grooves 4 for the fastening to the rotor or shaft of the turbine or compressor. Furthermore, the side plates 32 are provided with a plurality of cavities 34 of a diameter d for receiving the clamping bolts 33 in the assembled state. Furthermore, the side plates 32 are provided with guide surfaces 35 as shown in FIG. 5A and FIG. 5B. These guide surfaces 35 are provided for guiding the clamping bolts 33 when the fastening system 10 is installed within a turbine or a compressor. However, these guide surfaces 35 are not necessary in any case in order to form the intermediate fastening component 3 according to an embodiment of the present invention.

Finally, the intermediate fastening component 3 of this embodiment includes three clamping bolts 33 as shown in FIGS. 6A and 6B. In general case, the number of these bolts can vary with respect to design needs of the particular component. The clamping bolts 33 are here of a cylindrical round shape and have on their respective free ends two slopes 37 of an angle β. These slopes 37 are adapted to the respective assembly and design needs on the site of installation of the clamping bolts 33. However, the clamping bolts 33 can have different shapes and may be provided without such slopes 37. When the intermediate fastening components 3 are assembled within a fastening system 10 of a gas turbine or the like, the clamping bolts 33 are inserted into the cavities 34 of the circumferential side plates 32, with the upper platform 31 also fastened to the side plates 32 by means of the combination of a root 36 and the fastening groove 5 of the side plates 32. The diameter D of the clamping bolts 33 is slightly smaller than the diameter d of the cavities 34, which enables an easy mounting and disassembly. The upper platform 31 as well as the side plates 32 can be realized of any material, such as ordinary steel or composite materials, and the shapes of these parts 31, 32 can be optimized depending on the respective external thermal and mechanical loading during an operation of the engine. For example, the upper platform 31 can be realized with such assembly tolerances in the circumferential direction that it may easily be installed with comparatively small clearances to the circumferential lateral sides of the blades, which are to be fastened by means of the fastening system 10. On the other hand, according to an embodiment of the present invention, at least the clamping bolts 33 are made of a specific material, i.e. a so-called shape memory alloy. Through the specific comportment of such a material of the clamping bolts 33, a clamping effect is provided for the secure fastening of the turbine blades 1 on a rotor.

Depending on the operation conditions of the engine (turbine, compressor or the like) and namely the operation temperature ranges, the material of the clamping bolts 33 is chosen such that the following functionalities of the clamping bolts 33 are provided: during a shutdown of the engine, for example during the time of assembly or in case of a maintenance of the engine, the temperature is below a so-called transformation temperature of the chosen shape memory alloy for the clamping bolts 33. In this situation, the material of the clamping bolts 33 is ductile and metastable such that the clamping bolts 33 may easily be deformed and can therefore be installed or disassembled by means of simple tools or even by hand. Only during an operation of the engine at higher temperatures and/or an increased loading, the clamping effect of the clamping bolts 33 is triggered such that the clamping bolts 33 are deformed in order to clamp the intermediate fastening components 33 within the mounting groove of a rotor and against the lateral surfaces of the root sections of the blades. In this situation of the nominal operation with usually increased temperatures, the material of the clamping bolts 33 is heated above the so-called austenite finish temperature, which leads to a deformation of the clamping bolts 33. This induced stress in the austenitic state of the clamping bolts 33 made of a shape memory alloy is used for the clamping of the entire system during a nominal operation condition of the turbine or compressor. Before assembling the hybrid fastening system 10, according to an embodiment of the invention, the clamping bolts 33 made of a shape memory alloy are pseudo-plastically deformed, as indicated by Δ1 in FIG. 6A. Due to the high ductility of the shape memory material or similar material of the clamping bolts 33 in this state, the initial deformation of the clamping bolts 33 may be realized by using simple tools. During the operation of the engine, the operational temperatures will increase and will trigger the transformation of the clamping bolts 33, i.e. the deformation in the amount of Δ1 to the original shape of the clamping bolts 33. Due to this deformation, the clamping effect of the complete fastening system according to an embodiment of the invention is provided, without requiring small tolerances for the manufacturing of the intermediate fastening components, as is the case in the prior art intermediate fastening components made of a single solid element as shown in FIG. 2. By means of this, a kind of self-tolerance hybrid fastening system is realized by an embodiment of the invention. As a shape memory alloy or similar material having a pseudo-elasticity behavior, any shape memory alloy known to a person skilled in the art can be used. The transformation of the material from the austenitic state into the martensite state and vice versa can be triggered as explained due to the operation temperatures. According to an alternative embodiment, also external mechanical loadings or other loadings, such as electromagnetic loadings, can be used to trigger the transformation of the clamping parts, i.e. to provide the clamping effect of the intermediate fastening components 3 according to an embodiment the invention. In the described embodiments of the invention, there are three clamping bolts 33 mounted between two respective side plates 32 (cf. FIG. 3A). However, it is clear that the number of clamping parts 33 can be different, as well as the number of side plates 32, depending on the respective design of the turbine or compressor. Also the overall cross-section form of the side plates 32, the upper platform 31 and the clamping bolts 33 may be different as long as the clamping effect of the fastening system is triggered by operation conditions and the clamping parts 33 are realized on the basis of a so-called shape memory alloy or similar material having a pseudo-elasticity behavior, such as a bi-metal.

In an embodiment, the fastening system 10 has the advantage of an easy installation and disassembly: the intermediate fastening components 3 made of a plurality of distinct parts or elements are not required to be manufactured within very small tolerances as in the case of solid intermediate fastening components. After a shutdown of an engine and after a decrease of the temperature to ambient temperature, for example, the transformation of the material of the clamping bolts 33 enables an easy disassembly of the intermediate fastening components 3 and therefore the blades 1 without the requirement of special tooling. Furthermore, with the fastening system, according to an embodiment of the invention, an optimization of mass can be achieved, since the different parts of the intermediate fastening components 3 can be adapted to the respective requirements, i.e. the loadings or temperatures. All in all, a comparatively light-weight construction of the fastening system 10 is given. Also in view of transport and storage, the fastening system 10 is optimized, since the separate parts can easily be adjusted to the respective requirements at the installation site by using only simple tooling.

The fastening system 10, according to an embodiment of the invention, using clamping bolts 33 made of a shape memory alloy enhances also the damping properties of the fastening system: a common problem of turbines or compressors are the damages due to vibration resonances, which are generated during the operation. The blade rubbing against a housing often leads to a high-cyclic fatigue damage in the upper part of the blades where the material damping is rather small. The vibration waves are propagated to the fastening system. With the fastening system of the present invention, the propagation of vibration waves reaches the side plates of the intermediate fastening components that are fastened circumferentially by the clamping bolts 33 made of the shape memory alloy. The vibration deformation on the contact interface of the blades and the side plates 32 is damped by the martensitic twin boundary movements of the clamping bolts 33 realized of the shape memory alloy. Therefore, the vibration waves do not reflect at all or at much less amplitudes as compared to such prior art fastening systems. Embodiments of the invention do not only provide a reliable blade fastening, but are furthermore easy to install and enable an easy disassembly of such turbines. The different parts of the fastening system are not required to be manufactured with very small tolerances, and the system has an automatic adjustment of the specific pre-described installation position due to the clamping effect of the clamping parts 33 made of a shape memory alloy.

According to an embodiment of the invention, not only the clamping bolts 33, but also other parts of the intermediate fastening components 3 can be realized on the basis of a so-called shape memory alloy. Also the clamping bolts 33 are not necessarily completely made of a shape memory alloy, but may include a core part of ordinary steel or ordinary alloy, on which a spring element or the like is mounted, which is made of the shape memory alloy. The type of the shape memory alloy and the shape of the clamping bolts 33 are chosen depending on the respective operational conditions during the operation of the engine (turbine). If, for example, a turbine includes different stages with different operation temperature ranges, the respective intermediate fastening components are adapted to these different temperatures by choosing an appropriate type of material for the clamping bolts 33. This is also applicable on other loading, for example centrifugal force depending on the rotational speed.

This written description uses examples to disclose the invention, including the preferred embodiments, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal languages of the claims.

What is claimed is:

1. A mechanical fastening system for rotating or stationary components, comprising:
a circumferential mounting groove configured to receive root sections of the rotating or stationary components as well as intermediate fastening components for fixation of the intermediate fastening components in equidistance positions,
wherein the intermediate fastening components comprise:
at least an upper platform and at least a side plate having a groove for mounting on the rotating or stationary components, wherein the intermediate fastening components are made of a plurality of distinct parts of different materials from which at least one clamping part is made of or comprises a shape memory alloy having a pseudo-elasticity behavior.

2. The fastening system according to claim 1, wherein the at least one clamping part made of a shape memory alloy is a clamping bolt.

3. The fastening system according to claim 1, wherein the platform and the side plate are separate parts mounted to one another by a groove/undercut combination.

4. The fastening system according to claim 1, wherein the side plate comprises a cavity configured to receive the clamping part made of a shape memory alloy.

5. The fastening system according to claim 1, further comprising two or more circumferential side plates.

6. The fastening system according to claim 1, further comprising spring elements configured to fasten the intermediate fastening components.

7. The fastening system according to claim 1, wherein the side plate comprises a guide surface or guiding groove configured to receive and guide a clamp element.

8. The fastening system according to claim 1, further comprising a plurality of clamping parts made of a shape memory alloy.

9. The fastening system according to claim 1, wherein the at least one clamping part of the intermediate fastening components has an inner core made of steel or composite material, on which core a helical spring is wound made of a shape memory alloy showing a pseudo-elasticity behavior.

10. The fastening system according to claim 1, wherein the type of shape memory alloy for the clamping part is specifically selected depending on the temperature or other loading range during operation of a turbine or compressor at a respective installation location or stage.
